(19) United States
(12) Patent Application Publication
(10) Pub. No.: US 2015/0125333 A1
(43) Pub. Date: May 7, 2015

(54) BELOW SURFACE LASER PROCESSING OF A FLUIDIZED BED

(71) Applicants: Gerald J. Bruck, Oviedo, FL (US); Ahmed Kamel, Orlando, FL (US)

(72) Inventors: Gerald J. Bruck, Oviedo, FL (US); Ahmed Kamel, Orlando, FL (US)

(21) Appl. No.: 14/071,727

(22) Filed: Nov. 5, 2013

(51) Int. Cl. B22F 3/105; B22F 3/00

(52) U.S. Cl. CPC B22F 3/1055; B22F 3/003; B22F 2003/1057; B33Y 10/00; B33Y 30/00; B33Y 50/02
USPC 419/1; 425/78

(57) ABSTRACT

A system and process of additive manufacturing using a fluidized bed of powdered material (14) including powdered metal material (14′) and powdered flux material (14′)′ including heating the powdered material with an energy beam (20) delivered from a location below a top surface (25) of the powdered material. The powdered bed is fluidized by introduction of an inert or non-inert gas into a chamber (12). As the powdered material is heated, melted and solidified, a layer of slag (32) forms over a deposited metal (38) and is then removed so that fluidized powdered settling on a previously deposited area (34) can be heated, melted and solidified to build up a component (22).

### FIELD OF THE INVENTION

This invention relates generally to the field of casting, forming or repairing metal components and parts from a bed of powdered metals. More specifically, this invention relates to using a fluidized bed of powdered material to cast or repair parts wherein the powdered material is composed of superalloy metals and other materials.

### BACKGROUND OF THE INVENTION

Welding processes vary considerably depending upon the type of material being welded. Some materials are more easily welded under a variety of conditions, while other materials require special processes in order to achieve a structurally sound joint without degrading the surrounding substrate material.

Common arc welding generally utilizes a consumable electrode as the feed material. In order to provide protection from the atmosphere for the molten material in the weld pool, an inert cover gas or a flux material may be used when welding many alloys including, e.g. steels, stainless steels, and nickel based alloys. Inert and combined inert and active gas processes include gas tungsten arc welding (GTAW) (also known as tungsten inert gas (TIG)) and gas metal arc welding (GMAW) (also known as metal inert gas (MIG) and metal active gas (MAG)). Flux protected processes include submerged arc welding (SAW) where flux is commonly fed, flux cored arc welding (FCAW) where the flux is included in the core of the electrode, and shielded metal arc welding (SMAW) where the flux is coated on the outside of the filler electrode.

The use of energy beams as a heat source for welding is also known. For example, laser energy has been used to melt pre-placed stainless steel powder onto a carbon steel substrate with powdered flux material providing shielding of the melt pool. The flux powder may be mixed with the stainless steel powder or applied as a separate covering layer. To the knowledge of the inventors, flux materials have not been used when welding superalloy materials.

It is recognized that superalloy materials are among the most difficult materials to weld due to their susceptibility to weld solidification cracking and strain age cracking. The term “superalloy” is used herein as it is commonly used in the art; i.e., a highly corrosion and oxidation resistant alloy that exhibits excellent mechanical strength and resistance to creep at high temperatures. Superalloys typically include a high nickel or cobalt content. Examples of superalloys include alloys sold under the trademarks and brand names Hastelloy, Inconel alloys (e.g., IN 738, IN 792, IN 939), Rene alloys (e.g., Rene N5, Rene 80, Rene 142), Haynes alloys, Mar M, CM 247, CM 247 LC, C263, 718, X-750, ECY 768, 282, X45, PWA 1483 and CMSX (e.g., CMSX-4) single crystal alloys.

Weld repair of some superalloy materials has been accomplished successfully by preheating the material to a very high temperature (for example to above 1600° F. or 870° C.) in order to significantly increase the ductility of the material during the repair. This technique is referred to as hot box welding or superalloy welding at elevated temperature (SWET) weld repair and it is commonly accomplished using a manual GTAW process. However, hot box welding is limited by the difficulty of maintaining a uniform component process surface temperature and the difficulty of maintaining complete inert gas shielding, as well as by physical difficulties imposed on the operator working in the proximity of a component at such extreme temperatures.

Some superalloy material welding applications can be performed using a chill plate to limit the heating of the substrate material; thereby limiting the occurrence of substrate heat affects and stresses causing cracking problems. However, this technique is not practical for many repair applications where the geometry of the parts does not facilitate the use of a chill plate.

FIG. 9 is a conventional chart illustrating the relative weldability of various alloys as a function of their aluminum and titanium content. Alloys such as Inconel® IN718 which have relatively lower concentrations of these elements, and consequentially relatively lower gamma prime content, are considered relatively weldable, although such welding is generally limited to low stress regions of a component. Alloys such as Inconel® IN939 which have relatively higher concentrations of these elements are generally not considered to be weldable, or can be welded only with the special procedures discussed above which increase the temperature/ductility of the material and which minimize the heat input of the process. A dashed line 80 indicates a recognized upper boundary of a zone of weldability. The line 80 intersects 3 wt. % aluminum on the vertical axis and 6 wt. % titanium on the horizontal axis. Alloys outside the zone of weldability are recognized as being very difficult or impossible to weld with known processes, and the alloys with the highest aluminum content are generally found to be the most difficult to weld, as indicated by the arrow.

It is also known to utilize selective laser melting (SLM) or selective laser sintering (SLS) to melt a thin layer of superalloy powder particles onto a superalloy substrate. The melt pool is shielded from the atmosphere by applying an inert gas, such as argon, during the laser heating. These processes tend to trap the oxides (e.g., aluminum and chromium oxides) that are adherent on the surface of the particles within the layer of deposited material, resulting in porosity, inclusions and other defects associated with the trapped oxides. Post process hot isostatic pressing (HIP) is often used to collapse these voids, inclusions and cracks in order to improve the properties of the deposited coating. The application of these processes is also limited to horizontal surfaces due to the requirement of pre-placing the powder.

Laser microcladding is a 3D-capable process that deposits a small, thin layer of material onto a surface by using a laser beam to melt a flow of powder directed toward the surface. The powder is propelled toward the surface by a jet of gas, and when the powder is a steel or alloy material, the gas is argon or other inert gas which shields the molten alloy from atmospheric oxygen. Laser microcladding is limited by its low deposition rate, such as on the order of 1 to 6 cm³/hr. Furthermore, because the protective argon shield tends to dissipate before the clad material is fully cooled, superficial oxidation and nitridation may occur on the surface of the deposit, which is problematic when multiple layers of clad material are necessary to achieve a desired cladding thickness.

For some superalloy materials in the zone of non-weldability there is no known commercially acceptable welding or repair process. Furthermore, as new and higher alloy content superalloys continue to be developed, the challenge to develop commercially feasible joining processes for superalloy materials continues to grow.

With respect to original equipment manufacturing (OEM), selective laser sintering and selective laser melting of a static bed of powdered metal alloys have been suggested as alternative manufacturing processes; however, components produced using these processes are with limited productivity and quality. In addition, processing time remains an issue because parts are formed by very thing incrementally deposited layers by translating the part vertically downward to introduce a new layer of powder for melting. Moreover, the interface between incrementally processed layers or planes is subject to defects and questionable physical properties.

Casting a part from a fluidized bed of a powdered metal is disclosed in U.S. Pat. No. 4,818,562 (the '562 Patent), the content of which is fully incorporated herein by reference. The '562 Patent generally discloses the introduction of a gas into a bed of powdered metal and selectively heating regions of the powdered metal using a laser. In particular, the '562 Patent discloses the introduction of an inert gas such argon, helium, and neon. The inert gas is provided to displace any atmospheric gases that may react with the hot or molten metal to form metal oxides, which may compromise the integrity of a component. The '562 Patent also discloses that gas used to fluidize the powder may be a reactive gas such as methane or nitrogen; however, without introduction of the inert or other shielding mechanism, the risk of that the constituents of the molten metal will react with available elements remains. Moreover, system and process disclosed in the '562 Patent is limited to processing the surface of the bed with a part or component submerged in the bed.

### BRIEF DESCRIPTION OF THE DRAWINGS

The invention is explained in the following description in view of the drawings that show:

FIG. 1 is a schematic illustration of a system and process for repair or manufacture of a component using a fluidized bed of powdered material including powdered metal and powdered flux materials.

FIG. 2 is a partial sectional view of an energy beam exit portal with a permeable membrane.

FIG. 3 is an embodiment of the invention in which an energy beam source is disposed outside of the processing chamber so that a laser beam is transmitted through optically transmissive panels of the chamber.

FIG. 4 is an embodiment of the invention including an energy beam source positioned above the fluidized bed in combination with a below surface energy beam source.

FIG. 5 is a schematic illustration of the process showing a layer of slag formed over a deposited metal substrate.

FIG. 6 is a top view the laser tube with an attached slag tool.

FIG. 7 is an elevational view of the laser tube and slag tool of FIG. 6.

FIG. 8 illustrates an energy beam overlap pattern.

FIG. 9 is a prior art chart illustrating the relative weldability of various superalloys.

### DETAILED DESCRIPTION OF THE INVENTION

The present inventors have developed a materials joining process that can be used successfully to clad, join and repair the most difficult to weld superalloy materials, and to manufacture or cast original equipment or components. While flux materials have not previously been utilized when welding superalloy materials or in the original manufacture of parts or components, embodiments of the inventive system and process advantageously apply a powdered flux material during a laser microcladding process and/or in a laser additive manufacturing process. The powdered flux material is effective to provide beam energy trapping, impurity cleansing, atmospheric shielding, bead shaping, and cooling temperature control in order to accomplish crack-free joining of superalloy materials without the necessity for high temperature hot box welding or the use of a chill plate or the use of inert shielding gas. While various elements of the present invention have been known in the welding industry for decades, the present inventors have innovatively developed a combination of steps for a superalloy additive manufacturing process that overcomes the long-standing limitations of known selective laser melting and sintering processes for these materials. To that end, the inventors have discovered that by fluidizing a bed of powdered material that includes both powdered metal materials and powdered flux materials substrates can be formed continuously without incrementally forming layers to build up a substrate, and without the need of introduction of expensive inert gases.

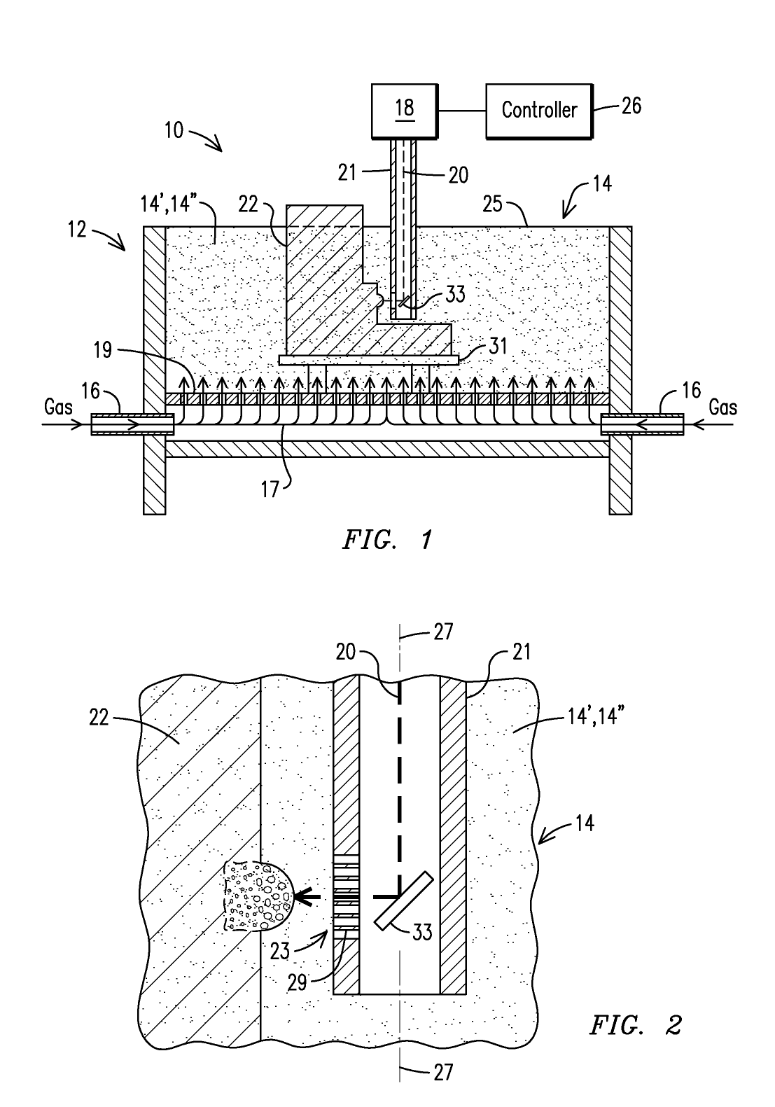

FIG. 1 illustrates an additive manufacturing system and process such as selective laser sintering or selective laser melting, collectively referred to herein as selective laser heating, in accordance with an embodiment of the invention. An additive manufacturing apparatus 10 includes a chamber 12 filled with bed of powdered material 14 (powdered bed, fluidized bed or bed) including powdered metal material 14′ and powdered flux material 14″. Powder material may also be of composite metal and flux for improved consistency of fluidization. The bed of powdered material 14 is fluidized by introducing a gas through one or more conduits 16, which are in fluid communication with a plenum 17 at the bottom of the chamber 12. A diffuser plate 19 is provided to separate the plenum 17 from bed 14 and generally uniformly distributes the fluidizing gas in the chamber 12. An example of such diffuser plate is 20 micron, 46 percent porosity, 3 mm (⅛ inch) thick, sintered sheet material of type 316L stainless steel available from Mott Corporation.

Gases that may be used to fluidize the bed 14 include inert gases such as argon or helium. However, because the flux material 14″ serves as protective shield to powdered metal material 14′ or molten metal during heating, less expensive reactive or semi-reactive gases such as methane, nitrogen, oxygen, carbon dioxide or compressed air may be used. As one skilled in the art will appreciate, the flow rate of the fluidizing gas must be controlled to adequately fluidize the bed 14 so that a sufficient amount of powdered material 14 will settle for processing and such flow rate will depend on a number of inter-related parameters including volume of the bed 14 and/or chamber 12, density of the powdered material 14, particle size etc. The flux 14″ may be coarser than the metal powder to enhance consistency and uniformity of fluidization of both metal and flux particles. That is, flux material 14″ tends to be less dense than the metal material 14′; therefore, small metal particles may be better matched in terms of fluidizing larger but less dense flux particles. Accordingly, the fluidizing medium flow rate can uniformly fluidize both the powdered flux material 14″ larger particles and powdered metal material 14′ smaller particles.

A scanning system 18 directs an energy beam such as laser beam 20 from below a top surface 25 of the fluidized powdered bed 14 to selectively heat (melt, partially melt or sinter) and solidify regions of the powder to form a portion of component 22. With respect to the embodiment shown in FIGS. 1 and 2, the scanning system 18 includes a beam transmission tube 21 submerged in the fluidized bed 14. The tube 21 preferably has opaque walls or surfaces so that the laser beam 20 is directed through an exit portal 23 disposed below the surface of the bed of powdered material 14. The term “below a top surface” is intended to encompass embodiments in which the laser beam exit portal 23 is submerged within the fluidized bed 14, or is positioned outside the chamber 12, but still below a plane defined at least in part by the top surface 25 of the bed 14.

As shown in FIG. 2, one or more mirrors 33 may be disposed within the tube 21 to control the direction of the beam path through the exit portal 23. These mirrors 33 may be moveable using mechanisms or techniques known to those skilled in the art to control the direction of travel of the beam path.

An optically transmissive membrane 35 may be fixed in the portal 23 to keep portal 23 free of melted powdered material 14. The membrane 35 may be composed of an optically transmissive solid material such as glass or quartz or it may comprise of gas permeable material wherein gas may be supplied through the tube 21 and membrane 35 to displace the powdered material 14 relative to the portal 23 so that melted material does not contact the membrane 35. Alternatively, the portal 23 may not require membrane 35 if gas is supplied to keep the portal 23 free of any melted powdered material 14. To that end, the gas supplied through the tube 21 and exit portal 23 may displace metal and flux particles toward the component 21 surface which may be partially melted by the laser beam 20. Surface tension at the molten component 22 surface causes metal and flux particles to adhere to the component for melting so horizontally disposed elements of the component 22 may be developed.

Relative movement between the laser beam 20 and component 22 may be controlled in accordance with a predetermined pattern or shape of the component 22 or in accordance with a programmable path or predetermined shape of the component 22. In an embodiment the scanning system 18 includes one or more controllers 26, or software, that controls movement of the tube 21 and laser beam 20 to follow a predetermined pattern or shape of the component 22, including dimensions thereof, along horizontal X and Y axes and along a vertical Z axis. In addition, or alternatively, the scanning system 18, tube 21 and beam 20 may be configured so that the tube 21 pivots or rotates about a central longitudinal axis 27. In this manner, the laser beam 20 can be used to form internal parts of the component 22. In addition, the scanning system 18 may be configured to rotate around the component 22 formed within chamber 12, which may require the tube 21 to pivot about the central longitudinal axis 27 so the beam 20 remains directed toward the component 22.

Yet another alternative is to form the component 22 on an X-Y translation stage positioned in the chamber 12 to move the component 22 relative to the laser beam 20. In addition, a surface of the chamber 12 on which the component is supported may be rotatable to move the component 22 relative to the beam 20. In addition, while the embodiment shown in FIGS. 1 and 2 includes a single laser beam 20, it is possible to combine several laser beams that selectively scan the powdered material 14 from a location beneath surface, and/or the beam from a single laser can be split so that identical parts can be simultaneously formed.

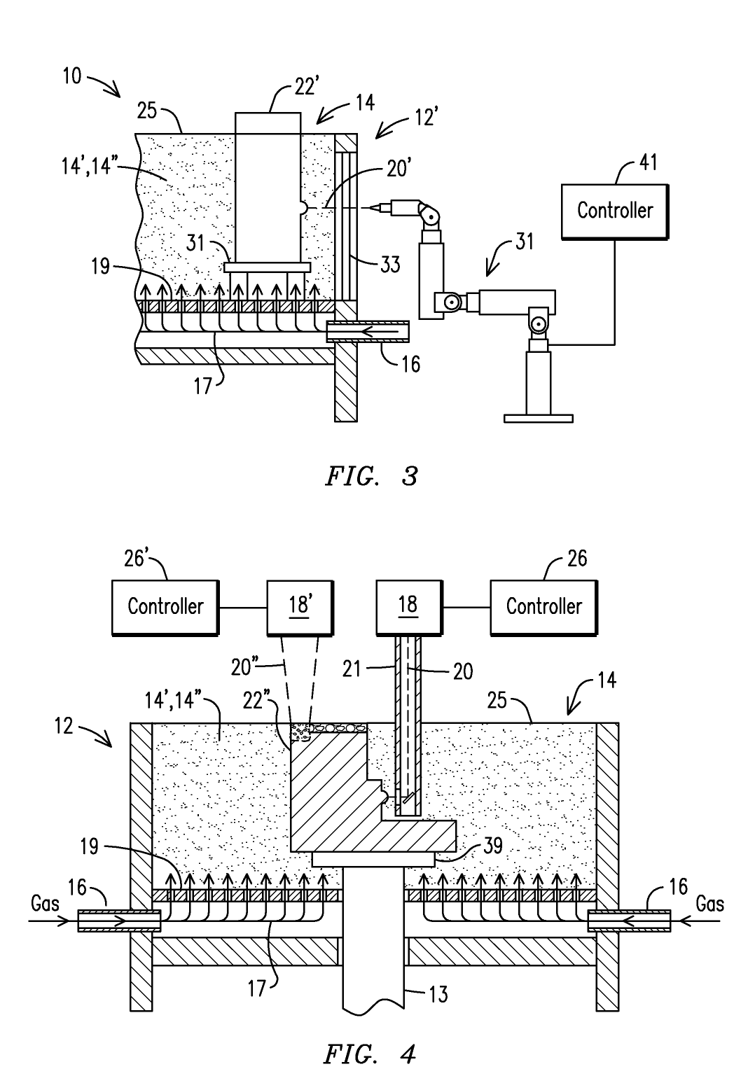

In an embodiment shown in FIG. 3, the laser beam 20′ is positioned outside chamber 12′ which has optically transmissive panels 29 so the beam can selectively scan powdered material 14 below the surface thereof. As shown, a robotically controlled articulating assembly 31 controls movement of the laser beam 20′ relative to the component 22′. The articulating assembly 31 may be configured to control movement of the beam 20′ across the surface of the bed 14 as well as selectively scanning the bed 14 below its surface. Alternatively, the beam 20′ may be used with any combination of beams 20 shown FIGS. 1 and 2, as well as the scanning systems shown in FIG. 4. In addition, the tube 21 may be configured as a robotically driven articulating assembly to scan or move the beam 20 relative to the component 22. As one skilled in the art will appreciate, the flow rate of the fluidizing gas must be controlled to adequately fluidize the bed 14 so that a sufficient amount of powdered material 14 will settle for processing and such flow rate will depend on a number of inter-related parameters including volume of the bed 14 and/or chamber 12, density of the powdered material 14, particle size etc.

With respect to FIG. 4, a scanning system 18′ directs a laser beam 20″ toward the top surface 25 of the fluidized powdered bed 14 to heat (melt, partially melt or sinter) and solidify regions of the powder 14 to form a portion of component 22″. The component 22″ is formed on a platen 24 that is operatively connected to a fabrication piston 13 that moves downward to allow fluidized powdered material 14 to settle on a previously formed or deposited metal substrate. The energy beam 20″ then selectively scans the bed of powdered material at those areas where the powdered material 14 has settled on a previously formed substrate or deposited metal. As shown, the scanning system 18′ may be used to develop a top portion of the component 22″, while the scanning system 18 and beam 20 develop or repair portions of the component 22″ below the surface 25 of the bed 14. A controller 26 may be provided to control relative movement of the beam 20″ in accordance with a programmable path and/or a predetermined shape of the component 22″.

When used in connection with the manufacture of a component, in any of the embodiments of FIGS. 1-4, the component 22 may be formed on a support plate 37, which may have a metal composition similar to that of the component 22 to be formed. For example, the plate 37 may be composed of a nickel based superalloy when developing components for a turbine engine. When the manufacture of the component 22 is completed, the plate 37 is separated from the component 22 using known metal cutting techniques.

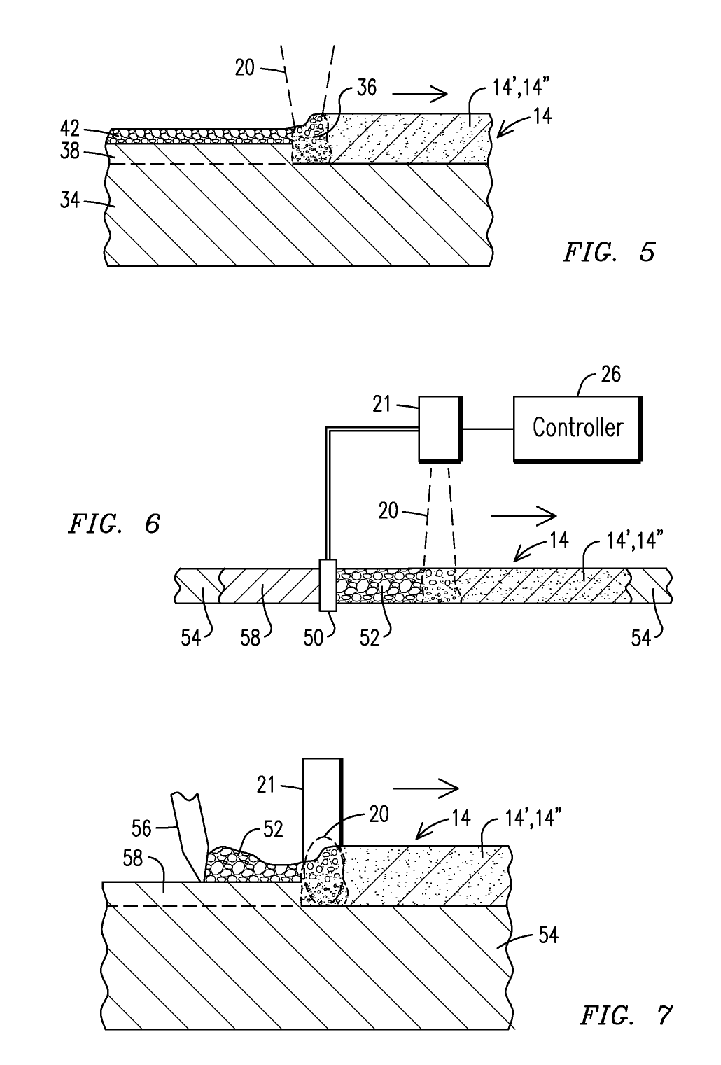

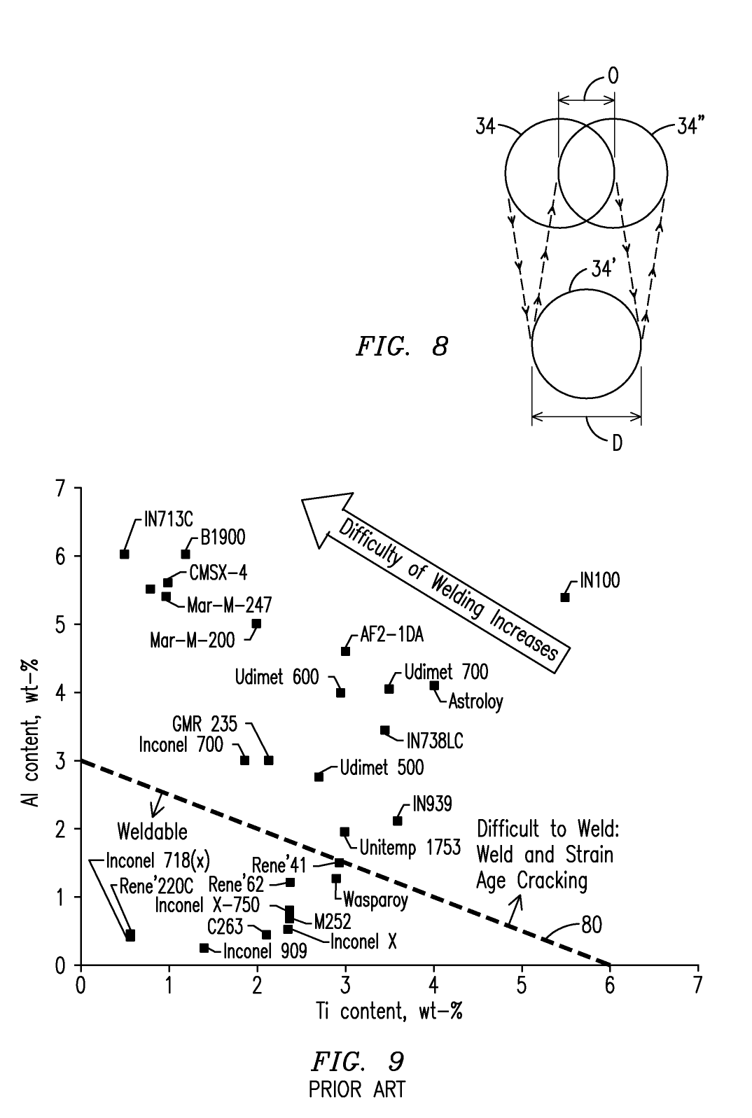

In addition, dimensions of the laser beam 20 may be controlled to vary according to corresponding dimensions of the component. For example, in FIG. 5 referred to below in more detail, the energy beam 20 has a generally rectangular configuration. A width dimension of the laser beam 20 may be controlled to correspond to a changing dimension, such as thickness, of a substrate of the component 22. Alternatively, it is possible to raster a circular laser beam back and forth as it is moved forward along a substrate to effect an area energy distribution. FIG. 8 illustrates a rastering pattern for one embodiment where a generally circular beam having a diameter D is moved from a first position 34 to a second position 34′ and then to a third position 34″ and so on. An amount of overlap O of the beam diameter pattern at its locations of a change of direction is preferably between 25-90% of D in order to provide optimal heating and melting of the materials. Alternatively, two energy beams may be rastered concurrently to achieve a desired energy distribution across a surface area, with the overlap between the beam patterns being in the range of 25-90% of the diameters of the respective beams.

Inasmuch as powdered material 14 includes the powdered flux material 14″ a layer of slag forms over a deposited metal when the laser beam 20 heats and melts the powdered metal 14′ and powdered flux material 14″. FIG. 5 is a schematic illustration of the fluidized powdered material 14, including the powdered metal 14′ and powdered flux material 14″, which includes material 14 fluidized over and/or some material 14 having settled on a previously deposited or formed metal substrate 34. Accordingly, when the beam 20 traverses the powdered material 14 by movement of the beam 20 by relative movement between the beam 20 and component 22, the powdered metal 14′ and powdered flux material 14″ are melted as represented by the molten region 36 and a metal deposit 38 is formed over a previously formed metal deposit or substrate 34 and covered by a layer of slag 42. Preferably, the beam 20 at least partially melts a surface of the substrate 34 so that the metal deposit 38 fuses with the previously formed substrate. Surface tension at a partially melted area of the substrate 34 promotes adhesion of particles to the substrate 34 for melting and solidification of fluidized particles. In an embodiment of the inventive system or process, the layer of slag 42 may be removed after the energy beam 20 has completed a scan of the powdered material 14 to form a metal layer or substrate of the component 22. In such an embodiment, component 22 is formed by incrementally depositing or forming metal layers and removing corresponding layer of slag 42.

In an embodiment shown in FIGS. 6 and 7, the repair or manufacturing process is performed continuously wherein a layer of slag 52 is removed from recently deposited metal 58 so that fluidized powdered material 14 disposed over a previously deposited metal substrate 54 can be heated, melted and solidified to continuously build up and form the component 22. As shown, the system and process include a slag removal tool 50 that is disposed adjacent to the component 22 to remove the layer of slag 52 after the powdered metal 14′ is heated, melted and solidified. For example, the embodiment shown in FIGS. 6 and 7, the slag tool 50 is operatively connected to the tube 21. The tube 21 and beam 20 may move relative to a stationary component and the tool 50 removes the layer of slag 52 as it follows the processing trail of the beam 20. Alternatively, the component 22 may move relative to a stationary tube 21, or both the component 22 and tube 21 and beam 20 may be moving in accordance with a predetermined shape of the component 22.

As known to those skilled in the art, the slag removal tool 50 includes a wedge-shaped head 56 to separate the slag layer 52 from the metal 54. In an embodiment, vibrational energy, such as sonic or ultrasonic energy, may be applied to the head 56 to selectively remove the layer of slag 52. Such slag removal tool 50 may be hollow and fit to a vacuum supply to suck slag through its core and thereby to remove slag from the fluidized bed in a continuous fashion. In addition, the slag tool 50 is positioned relative to the beam 20 and component 22 so that layer of slag 52 remains on a recently deposited metal 38, 58 a sufficient time until the solidified and deposited metal was below the temperature of excessive oxidation, which would normally correspond to at least a distance of 55 mm.

The slag 52 is less dense than the powdered metal material 14′ and powdered flux material 14″, so when the layer of slag 42, 52 is removed in the form of larger particles, the slag 52 may not fluidize as the powdered material but it will remain toward or at the surface 25 of the bed 14. Slag removal systems such as those disclosed in the commonly owned application U.S. application Ser. No. 13/755,157, which is incorporated herein by reference, may be included with embodiments of the subject invention to essentially rake the surface 25 of the bed 14 to remove slag 52 from the chamber 12 and dump the slag 52 in to an adjacent bin. The removed slag 52 can then be recycled into reusable powdered flux material. Such slag removal systems may be operatively associated with the scanning system 18 whereby, the surface 25 is raked at predetermined time intervals to remove slag from the chamber 12. Accordingly, the tool 50 shown in FIG. 4 may be moved for a slag removal step. Alternatively, such slag removal systems may be used in place of the slag tool 50 to remove slag layers 42, 52 from recently deposited metal and remove the slag 52 from the chamber 12.

In the event powdered material 14 needs to be added to the chamber 12, known methods to introduce powdered materials, such as those discussed in U.S. Pat. No. 4,818,562 may be used. Another well-known technique to supplement the powdered material 14 of chamber 12 providing the apparatus 10 feed bin and a feed roller to move powdered material from the bin to the chamber 12 between scanning steps of the laser beam 20. To that end, the chamber 12 may be equipped with sensors, such as optical-type sensors to detect when the surface 25 of the bed 14 drops below a predetermined level to initiate a sequence for adding powdered material 14.

The powdered metal 14′ and component 22, 22′, 22″ may be composed of a nickel-based superalloy having constituent elements such as Cr, Co, Mo, W, Al, Ti, Ta, C, B, Zr and Hf. Both Al and Ti are relatively volatile and both are reactive with oxygen and nitrogen. Accordingly, Al and Ti can be lost during repair or manufacture of a component, especially if a reactive gas such as air is used to fluidize the powdered material 14. It may be necessary to compensate for this loss by enriching the powdered metal 14′ and powdered flux material 14″ with Al and/or Ti. Most superalloy metal compositions include as much as 3% to about 6% by weight Al and/or Ti, so 3% may be a threshold concentration at which fluidizing gases such as CO₂ or inert gases are used instead of air.

Flux materials which could be used include commercially available fluxes such as those sold under the names Lincolnweld P2007, Bohler Soudokay NiCrW-412, ESAB OK 10.16 or 10.90, Special Metals NT100, Oerlikon OP76, Sandvik 50SW or SAS1. The flux particles may be ground to a desired smaller mesh size range before use. Any of the currently available iron, nickel or cobalt based superalloys that are routinely used for high temperature applications such as gas turbine engines may be joined, repaired or coated with the inventive process, including those alloys mentioned above. The bed may be heated using various heaters or techniques, such as a resistance heating coil disposed in the bed to keep the powder metal 14′ and flux 14″dry and to avoid porosity.

With prior art selective laser heating processes involving superalloy materials, powdered superalloy material is heated under an inert cover gas in order to protect the melted or partially melted powdered metal 14′ from contact with air. In contrast, the embodiment of the present invention illustrated in FIGS. 1-5 utilizes powdered superalloy material 14′ plus powdered flux 14″ as the powder 14, and thus the heating need not be (although it may optionally be) performed under an inert cover gas because melted flux provides the necessary shielding from air. The powder 14 may be a mixture of powdered alloy 14′ and powdered flux 14″, or it may be composite particles of alloy and flux, as described above. In order to enhance the precision of the process, the powder 14 may be of a fine mesh, for example 20 to 100 microns, or a sub-range therein such as 20-80 or 20-40 microns, and the mesh size range of flux particles 14″ may overlap or be the same as the mesh size range of the alloy particles 14′. The flux may also be coarser than the metal powder to enhance consistency and uniformity of fluidization of both metal and flux particles. That is, flux material 14″ tends to be less dense than the metal material 14′; therefore, small metal particles may be better matched in terms of fluidizing larger but less dense flux particles. Accordingly, the fluidizing medium flow rate can uniformly fluidize both the flux material 14″ larger particles and metal material 14′ smaller particles. The small size of such particles results in a large surface area per unit volume, and thus a large potential for problematic oxides formed on the alloy particle surface. Composite particles may minimize this problem by coating alloy particles with flux material. Furthermore, the melted flux will provide a cleaning action to reduce melt defects by forming shielding gas and by reacting with oxides and other contaminants and floating them to the surface where they form a readily removed layer of slag 52.

The flux 14″ functions as a light trap to assist in the absorption of laser energy, and the resulting slag layer 42, 52 slows the cooling rate and contains process energy. The flux 14″ may be formulated to contribute to the deposit chemistry in some embodiments. While not required, it may be advantageous to heat the powder 14 and/or the component 22, 22′, 22″ prior to a scanning or beam heating sequence. Post process hot isostatic pressing is also not required but may be used in some embodiments. Post weld heat treatment of the completed component 22, 22′, 22″ may be performed with a low risk of reheat cracking even for superalloys that are outside the zone of weldability as discussed above with regard to FIG. 9.

The flux material 14″ and resultant layer of slag 42, 52 provide a number of functions that are beneficial for preventing cracking of cladding, or recently deposited metal 38, 58 and the underlying substrate material 34, 54. First, they function to shield both the region of molten material and the solidified (but still hot) deposited metal 38 from the atmosphere in the region downstream of the laser beam 20, 20′, 20″. The slag floats to the surface to separate the molten or hot metal from the atmosphere and the flux may be formulated to produce a shielding gas in some embodiments, thereby avoiding or minimizing the use of expensive inert gas. Second, the slag 42, 52 acts as a blanket that allows the solidified material to cool slowly and evenly, thereby reducing residual stresses that can contribute to post weld reheat or strain age cracking. Third, the slag 42, 52 helps to shape the pool of molten metal to keep it close to a desired ⅓ height/width ratio. Fourth, the flux material 14″ provides a cleansing effect for removing trace impurities such as sulfur and phosphorous which contribute to weld solidification cracking. Such cleansing includes deoxidation of the metal powder. Because the flux powder is in intimate contact with the metal powder, it is especially effective in accomplishing this function. Finally, the flux material 14″ may provide an energy absorption and trapping function to more effectively convert the laser beam 20, 20′, 20″ into heat energy, thus facilitating a precise control of heat input, such as within 1-2%, and a resultant tight control of material temperature during the process. Additionally, the flux may be formulated to compensate for loss of volatized elements during processing or to actively contribute elements to the deposit that are not otherwise provided by the metal powder itself. Together, these process steps produce crack-free deposits of superalloy deposits or cladding on superalloy substrates at room temperature for materials that heretofore were believed only to be joinable with a hot box process or through the use of a chill plate.

The energy beams 20, 20′ 20″ in the embodiments of FIGS. 1-5, may be a diode laser beam having a generally rectangular cross-sectional shape, although other known types of energy beams may be used, such as electron beam, plasma beam, one or more circular laser beams, a scanned laser beam (scanned one, two or three dimensionally), an integrated laser beam, etc. The rectangular shape may be particularly advantageous for embodiments having a relatively large area to be clad; however, the beam may be adaptable to cover relatively small areas such as small distressed regions in need of repair. The broad area beam produced by a diode laser helps to reduce weld heat input, heat affected zone, dilution from the substrate and residual stresses, all of which reduce the tendency for the cracking effects normally associated with superalloy repair and manufacture.

Optical conditions and hardware optics used to generate a broad area laser exposure may include, but are not limited to: defocusing of the laser beam; use of diode lasers that generate rectangular energy sources at focus; use of integrating optics such as segmented mirrors to generate rectangular energy sources at focus; scanning (rastering) of the laser beam in one or more dimensions; and the use of focusing optics of variable beam diameter (e.g., 0.5 mm at focus for fine detailed work varied to 2.0 mm at focus for less detailed work). The motion of the optics and/or substrate may be programmed as in a selective laser melting or sintering process to build a custom shape deposit. To that end, the laser beam source is controllable so that laser parameters such as the laser power, dimensions of the scanning area and traversal speed of the laser 20, 20′ 20″ are controlled so that the thickness of the deposit 38, 58 corresponds to that desired to build on or restore the substrate 34, 54, or that metal is according to the predetermined configuration, shape or dimensions of the component 22, 22′, 22″.

Advantages of this process over known laser melting or sintering processes include: high deposition rates and thick deposit in each processing layer; improved shielding that extends over the hot deposited metal without the need for inert gas; flux will enhance cleansing of the deposit of constituents that otherwise lead to solidification cracking; flux will enhance laser beam absorption and minimize reflection back to processing equipment; slag formation will shape and support the deposit, preserve heat and slow the cooling rate, thereby reducing residual stresses that otherwise contribute to strain age (reheat) cracking during post weld heat treatments; flux may compensate for elemental losses or add alloying elements; and powder and flux preplacement or feeding can efficiently be conducted selectively because the thickness of the deposit greatly reduces the time involved in total part building.

The process disclosed herein may be useful for original equipment manufacturing or for rapid prototyping of parts. Furthermore, the process may be used for component repair applications, such as for forming a replacement blade tip on a gas turbine blade that has been removed from service for refurbishing. The present invention eliminates the need for inert cover gas, provides precise laser processing for tight tolerance control, provides a solution to the long-standing problem of oxides on fine superalloy powder used in selective laser heating processes, and allows for the crack-free deposition of superalloys having compositions beyond the previously known zone of weldability.

It will be appreciated that the use of powdered material facilitates the deposition of functionally graded materials, where the composition of the deposited material varies across time and space. For example, if the component 22, 22′, 22″ is a gas turbine vane, a platform portion of the vane may be a first composition and an airfoil portion of the vane may be a second, different composition. In other embodiments the alloy composition may vary from an interior wall to an exterior wall of a product, or from within a product to near its surfaces. The alloy composition may be varied in response to anticipated operating conditions requiring different mechanical or corrosion resistance properties, and with consideration of the cost of the materials.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. An additive manufacturing apparatus for making a metal component, comprising:
a chamber;
a bed of powdered material including powdered metal material; and
an energy beam scanning system that includes one or more beam exit portals disposed below a surface of the bed and through which an energy beam is transmitted to selectively scan portions of the powdered material from below the surface of the bed according to a predetermined shape of the component.

2. The apparatus of claim 1 wherein the energy beam scanning system comprises one or more controllers operatively associated with the energy beam and/or the chamber to control relative movement between the energy beam and the component according to the predetermined shape of the component.

3. The apparatus of claim 1, wherein the chamber includes optically transmissive walls and the exit portal is positioned outside of the chamber.

4. The apparatus of claim 1, wherein the exit portal is inside the chamber.

5. The apparatus of claim 1, wherein, the energy beam is a laser beam.

6. The apparatus of claim 1, wherein the powdered material comprises powdered flux material and the powdered superalloy material.

7. The apparatus of claim 6, further comprising a source of non-inert gas in fluid communication with an interior of the chamber to fluidize the bed of powdered material.

8. The apparatus of claim 1, wherein the exit portal is on a housing that is at least partially submerged in the bed of powdered material so the exit portal is beneath the surface of the bed of powdered material.

9. The apparatus of claim 1, further comprising a gas supply flowing through the exit portal to displace the powdered material relative to the exit portal.

10. The apparatus of claim 9, wherein an optically transmissive and gas permeable membrane covers the exit portal.

11. An additive manufacturing process comprising:
fluidizing a bed of powdered material comprising powdered metal material; and
selectively heating portions of the bed of powdered material from an energy beam exit portal located below a surface of the bed of powdered material to form a solidified metal deposit.

12. The process of claim 11, further comprising providing the bed of powdered material to comprise powdered superalloy material and powdered flux material.

13. The process of claim 12, further comprising supplying a gas flow through the exit portal to displace the powdered material relative to the exit portal.

14. The process of claim 13, further comprising providing an optically transmissive and gas permeable membrane to cover the exit portal.

15. The process of claim 12, wherein the powdered material comprises particles of a superalloy which comprises a composition beyond a zone of weldability defined on a graph of superalloys plotting titanium content verses aluminum content, wherein the zone of weldability is upper bounded by a line intersecting the titanium content axis at 6 wt. % and intersecting the aluminum content axis at 3 wt. %.

16. The process of claim 11, further comprising providing the bed of powdered material to comprise granulated particles formed as composite metal-flux particles.

17. An additive manufacturing process comprising:
fluidizing a bed of powdered material comprising powdered superalloy material and powdered flux material;
selectively scanning portions of the bed of powdered material with an energy beam from a location below a surface of the bed of powdered material to form a solidified metal deposit; and,
controlling movement of the energy beam according to a predetermined shape of a component to be formed.

18. The process of claim 17, wherein the powdered flux material, when heated, forms a layer of slag over the metal deposit, and the process further comprises:
removing the layer of slag from the metal deposit before again selectively scanning portions of the bed of powdered material disposed over the metal deposit layer.

19. The process of claim 17, wherein the powdered material is composed of particles of a superalloy which comprises a composition beyond a zone of weldability defined on a graph of superalloys plotting titanium content verses aluminum content, wherein the zone of weldability is upper bounded by a line intersecting the titanium content axis at 6 wt. % and intersecting the aluminum content axis at 3 wt. %.

20. The process of claim 17, further comprising supplying a gas flow through an optically transmissive and gas permeable membrane covering the exit portal to displace the powdered material relative to the exit portal.
